(19) United States
(12) Patent Application Publication
(10) Pub. No.: US 2025/0023256 A1
(43) Pub. Date: Jan. 16, 2025

(54) ANTENNA DEVICE AND WIRELESS MOBILE TERMINAL

(71) Applicants: Yungu (Gu’an) Technology Co., Ltd., Langfang (CN); Hefei Visionox Technology Co., Ltd., Hefei, Anhui (CN)

(72) Inventors: Huan-Chu HUANG, Taoyuan City (TW); Jie WU, Langfang (CN); Shuang CUI, Langfang (CN)

(73) Assignees: Yungu (Gu’an) Technology Co., Ltd., Langfang (CN); Hefei Visionox Technology Co., Ltd., Hefei (CN)

(21) Appl. No.: 18/901,586

(22) Filed: Sep. 30, 2024

(30) Foreign Application Priority Data
Nov. 17, 2023 (CN) 202311542521.5

(51) Int. Cl. H01Q 21/06; H01Q 1/12; H01Q 1/38

(52) U.S. Cl. CPC H01Q 21/06; H01Q 1/12; H01Q 1/38

(57) ABSTRACT

An antenna device and a wireless mobile terminal. The antenna device includes: a frame including a border and a hollow space surrounded and formed by the border; a support connected to the border and extending towards the hollow space; and an antenna assembly including a first antenna module and a second antenna module. The first antenna module is arranged on the support and includes a plurality of first antenna units distributed at intervals, and the second antenna module includes a plurality of second antenna units. The first antenna module and the support are insulated from each other, and the support includes a conductive material and is reused as at least a portion of the second antenna units.

### CROSS REFERENCE

The present disclosure claims priority to Chinese Patent Application No. 202311542521.5 titled “ANTENNA DEVICE AND WIRELESS MOBILE TERMINAL” filed on Nov. 17, 2023, which is incorporated herein by reference in its entirety.

### TECHNICAL FIELD

The present application relates to the technical field of electronic device, and in particular to an antenna device and a wireless mobile terminal.

### BACKGROUND

The functions of wireless communication devices, such as a mobile phone and a smart watch, are constantly evolving, and the requirements of the device appearance and the wireless communication performance by the market are also constantly increasing. How to improve the communication performance of the wireless mobile terminals has become an urgent technical problem to be solved.

### SUMMARY

Embodiments of the present application provide an antenna device and a wireless mobile terminal, which can improve the wireless communication performance of the wireless mobile terminal.

In a first aspect, embodiments of the present application provide an antenna device including: a frame, including a border and a hollow space surrounded and formed by the border; a support, connected to the border and extending towards the hollow space; and an antenna assembly, including a first antenna module and a second antenna module. The first antenna module is arranged on the support and includes a plurality of first antenna units spaced apart from one another, and the second antenna module includes a plurality of second antenna units. The first antenna module and the support are insulated from each other, and the support includes a conductive material and is reused as at least a portion of the second antenna units.

According to any one of the embodiments of the present application in the first aspect, the support is provided with a groove, and the first antenna units are located in the groove.

According to any one of the embodiments of the present application in the first aspect, a filling medium is provided between the first antenna units and inner wall faces of the grooves.

According to any one of the embodiments of the present application in the first aspect, a material of the filling medium includes at least one of fluorine material or liquid crystal polymer.

In a second aspect, embodiments of the present application provide a wireless mobile terminal including the antenna device according to any one of the above embodiments in the first aspect.

### BRIEF DESCRIPTION OF THE DRAWINGS

FIG. 1 is a structural schematic view of an antenna device according to an embodiment of the present application;

FIG. 2 is a locally enlarged structural schematic view of an antenna device according to an embodiment of the present application;

FIG. 3 is a structural schematic view of a support of an antenna device according to an embodiment of the present application;

FIG. 4 is a structural schematic view of a support of an antenna device provided with an antenna assembly according to an embodiment of the present application;

FIG. 5 is a sectional view of a support of an antenna device provided with an antenna assembly according to an embodiment of the present application;

FIG. 6 is a structural schematic view of the support of the antenna device provided with the antenna assembly shown in FIG. 4 from another perspective;

FIG. 7 is a structural schematic view of a support of an antenna device according to an embodiment of the present application from another perspective;

FIG. 8 is a locally structural schematic view of an antenna assembly of an antenna device according to an embodiment of the present application;

FIG. 9 is a structural schematic view of a support of an antenna device according to another embodiment of the present application;

FIG. 10 is a structural schematic view of a support of an antenna device provided with an antenna assembly according to another embodiment of the present application;

FIG. 11 is a structural schematic view of a support of an antenna device according to another embodiment of the present application;

FIG. 12 is a structural schematic view of a support of an antenna device according to another embodiment of the present application;

FIG. 13 is a structural schematic view of a support of an antenna device according to another embodiment of the present application;

FIG. 14 is a structural schematic view of a support of an antenna device according to another embodiment of the present application;

FIG. 15 is a structural schematic view of a support of an antenna device according to another embodiment of the present application;

FIG. 16 is a structural schematic view of a support of an antenna device provided with an antenna assembly according to another embodiment of the present application; and

FIG. 17 is a structural schematic view of a support of an antenna device according to another embodiment of the present application.

### REFERENCE NUMERALS

10. antenna device;
100. frame; 110. border; 110a. sub-segment; 120. hollow space; 130. bottom plate; 200. support; 201. first end; 202. second end; 210. connecting via holes; 220. groove; 230. filling medium; 240. supporting portion; 250. contact portion; 260. second feeding portion; 270. conductive plate;
300. antenna assembly; 301. first antenna module; 302. second antenna module; 310. first antenna unit; 320. second antenna unit; 330. first integrated circuit; 340. first feeding portion;
350. carrying portion;
400. shielding cover;
500, connector;
Y. first direction; X. second direction; Z. third direction.

### DETAILED DESCRIPTION

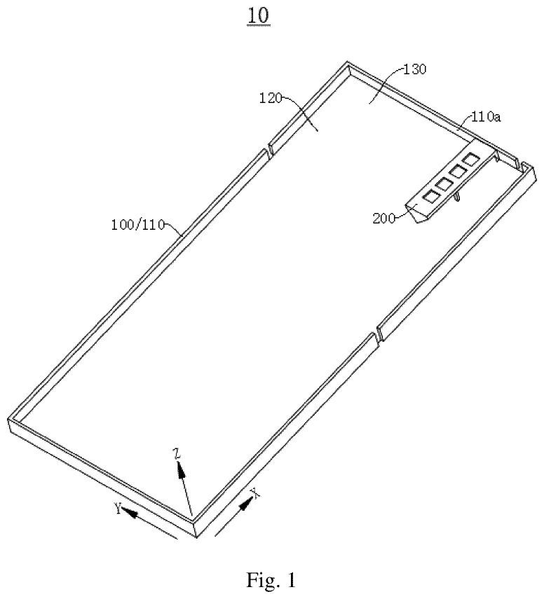

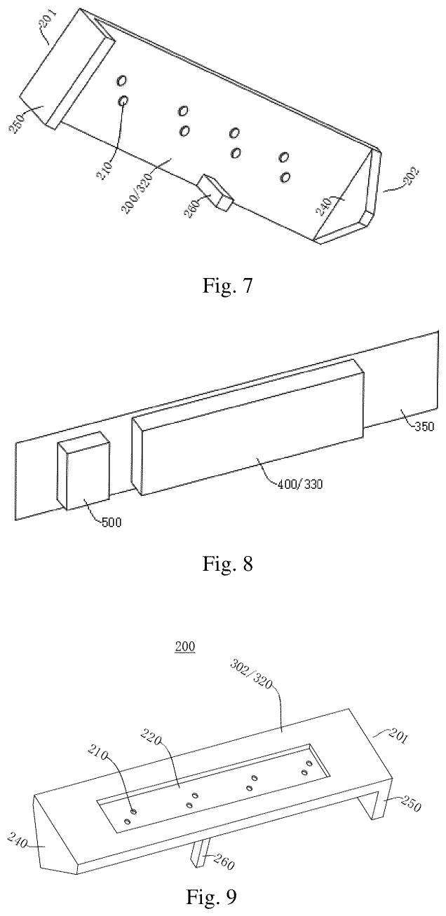

In order to better understand the present application, an antenna device and a wireless mobile terminal according to embodiments of the present application will be described in detail below with reference to FIG. 1 to FIG. 17.

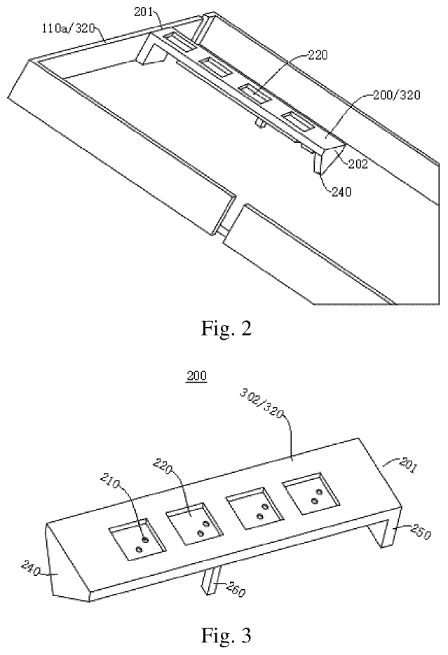

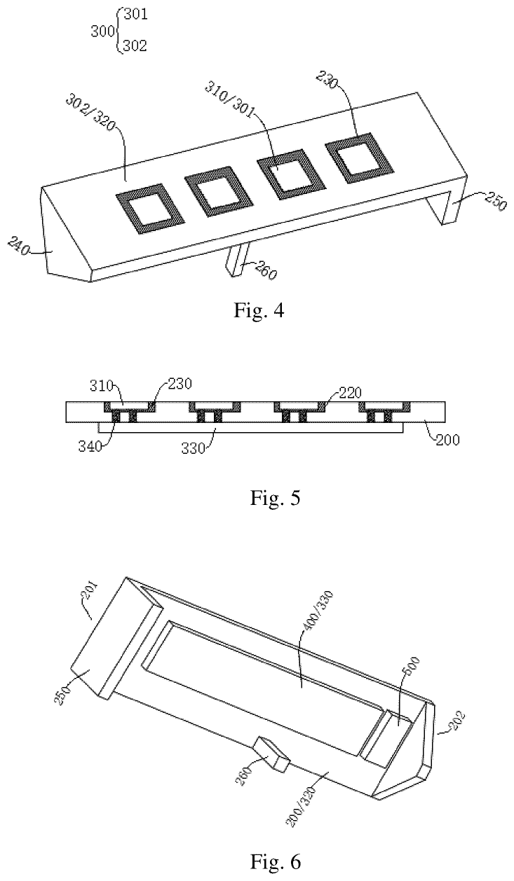

Referring to FIG. 1 to FIG. 4, FIG. 1 is a structural schematic view of an antenna device according to an embodiment of the present application; FIG. 2 is a locally enlarged structural schematic view of an antenna device according to an embodiment of the present application; FIG. 3 is a structural schematic view of a support of an antenna device according to an embodiment of the present application; and FIG. 4 is a structural schematic view of a support provided with an antenna assembly.

As shown in FIG. 1 and FIG. 4, in a first aspect, embodiments of the present application provide an antenna device 10. The antenna device 10 includes a frame 100, a support 200 and an antenna assembly 300. The frame 100 includes a border 110 and a hollow space 120 surrounded and formed by the border 110; the support 200 is connected to the border 110 and extending towards the hollow space 120; the antenna assembly 300 includes a first antenna module 301 and a second antenna module 302. The first antenna module 301 is arranged on the support 200 and includes a plurality of first antenna units 310 spaced apart from one another, and the second antenna module 302 includes a plurality of second antenna units 320. The first antenna module 301 and the support 200 are insulated from each other, and the support 200 includes a conductive material and is reused as at least a portion of the second antenna units 320.

In the antenna device 10 provided in the present application, the antenna device 10 includes the frame 100, the support 200 and the antenna assembly 300. The frame 100 can surround to form the hollow space 120 for the antenna assembly 300 and the support 200. The support 200 is connected to the border 110 and located in the hollow space 120 to provide an arranging position for the antenna assembly 300. The antenna assembly 300 includes the first antenna module 301 and the second antenna module 302, which can improve the antenna function. When the antenna device is used for the wireless mobile terminal, the wireless communication performance of the wireless mobile terminal can be improved. The first antenna module 301 includes the plurality of first antenna units 310 arranged on the support 200, which can support the first antenna units 310. The support includes the conductive material and can be reused as at least a portion of the second antenna units 320, so as to further improve the function of the support 200 and reduce a space occupied by the entire second antenna module 302.

Optionally, the antenna device 10 is used for the wireless mobile terminal. The wireless mobile terminal further include components such as a control board. The control board may be arranged in the hollow space 120. Optionally, the border 110 may be a middle frame of the wireless mobile terminal, and the border 110 is arranged to surround the wireless mobile terminal.

Optionally, the border 110 may be integrally formed, that is, the closed annular border 110 which is integrally formed surrounds to form the hollow space 120.

In some other embodiments, the border 110 may include a plurality of sub-segments 110a, which surround the hollow space 120. Optionally, each two adjacent sub-segments 110a are insulated from each other, for example, an insulating spacer may be arranged between each two adjacent sub-segments 110a to reduce the impact of the border 110 on the wireless signal transmission of the wireless mobile terminal. The embodiments of the present application take the border 110 including the plurality of sub-segments 110a as an example to illustrate.

There are various arrangements of the support 200, and the support 200 may be in a shape of plate, column or the like. Optionally, the support 200 is the shape of plate, so as to reduce a space occupied by the support 200 and facilitate the antenna assembly 300 arranging on the support 200. Optionally, the frame 100 further includes a bottom plate 130, the border 110 is connected to a peripheral side of the bottom plate 130, and the border 110 and the bottom plate 130 jointly surround to form the hollow space 120. Optionally, a distance between a surface of the support 200 away from the bottom plate 130 and the bottom plate 130 is less than or equal to a distance between a surface of the border 110 away from the bottom plate 130 and the bottom plate 130, that is, the support 200 is closer to the bottom plate 130 than the border 110 to the bottom plate 130, and the support 200 does not protrude from the border 110 in a direction away from the bottom plate 130, which can reduce an overall volume of the antenna device 10.

Optionally, the bottom plate 130 and the control board of the wireless mobile terminal can be reused as each other. Alternatively, the bottom plate 130 and the control board can be separately arranged.

Optionally, the plurality of first antenna units 310 can be arranged in a plurality of rows and columns on the support 200. The first antenna units 310 of each two adjacent rows can be aligned or misaligned with each other. The embodiments of the present application take the first antenna units 310 arranged in a single row as an example.

There are various arrangements of the first antenna module 301 and the second antenna module 302, for example, one of the first antenna module 301 and the second antenna module 302 is a millimeter wave antenna module, and the other is a non-millimeter wave antenna module, so that the antenna module 300 can transmit and receive millimeter wave signals and non-millimeter wave signals.

In some optional embodiments, the first antenna module 301 is the millimeter wave antenna module, and the first antenna units 310 are used to transmit and receive the millimeter wave antenna signals. An arrangement size of each of the first antenna units 310 on the support 200 is flexible, so that it can be set to be smaller and more suitable to transmit and receive the millimeter wave antenna signals. The second antenna module 302 is the non-millimeter wave antenna module, and the second antenna units 320 are used to transmit and receive the non-millimeter wave antenna signals. When the second antenna module 302 is the non-millimeter wave antenna module, an arrangement size of the support 200 that is reused as at least a portion of the second antenna units 320 can be set to be larger, so that the support 200 can support the plurality of first antenna units 310.

In some optional embodiments, as described above, when the frame 100 includes the bottom plate 130, the support 200 and the bottom plate 130 are spaced apart from each other, so that there is an arrangement space between the support 200 and the bottom plate 130. The first antenna units 310 can be selectively arranged on the side of the support 200 facing or away from the bottom plate 130.

For example, in some embodiments, referring to FIG. 1 to FIG. 5, the antenna assembly 300 further includes a first integrated circuit 330. One of the first integrated circuit 330 and the first antenna units 310 is arranged on the side of the support 200 facing the bottom plate 130, the other is (are) arranged on the side of the support 200 away from the bottom plate 130, and the first integrated circuit 330 is electrically connected to the first antenna units 310.

In these optional embodiments, the first integrated circuit 330 is electrically connected to the first antenna units 310, so that the first integrated circuit 330 can transmit the radio frequency signals to the first antenna units 310. The first integrated circuit 330 and the first antenna units 310 are arranged on two sides of the support 200, respectively. By utilizing the spaces at the two sides of the support 200, a spatial position occupied by the antenna assembly 300 can be further reduced, and a distance between the first integrated circuit 330 and the first antenna units 310 can be closer, so as to facilitate the electrical connection between the first integrated circuit 330 and the first antenna units 310.

In addition, since the support 200 includes the conductive material, the support 200 has a good heat-dissipating effect. The first integrated circuit 330 does not require an additional heat sink component, that is, it is no need to provide an additional heat-dissipating metal to the first integrated circuit 330, so that it can reduce the cost of the heat sink component, save the occupied space, improve the compactness of the overall system design and achieve a better overall competitiveness.

Optionally, the first integrated circuit 330 may include a first radio frequency integrated circuit and a first battery management integrated circuit. The first radio frequency integrated circuit is connected to the first antenna units 310, so as to transmit the radio frequency signals to the first antenna units 310. Optionally, the first integrated circuit 330 may include only the first radio frequency integrated circuit.

Optionally, the first integrated circuit 330 is arranged on the side of the support 200 facing the bottom plate 130, and the first antenna units 310 are arranged on the side of the support 200 away from the bottom plate 130. The first antenna units 310 are arranged further outward, which can reduce the impact of the support 200 on the signal transmission of the first antenna units 310 and enhance the signal transmission performance of the first antenna module 301.

Optionally, when the first antenna units 310 are arranged on the side of the support 200 away from the bottom plate 130, a distance between surfaces of the first antenna units 310 away from the bottom plate 130 and the bottom plate 130 is less than or equal to the distance between the surface of the border 110 away from the bottom plate 130 and the bottom plate 130, that is, the first antenna units 310 are closer to the bottom plate 130 than the surface of the border 110 away from the bottom plate 130 to the bottom plate 130, and the first antenna units 310 do not protrude from the border 110, which can further reduce the overall volume of the antenna device 10.

There are various ways to electrically connect the first antenna units 310 with the first integrated circuit 330. For example, the first antenna module 301 includes a first feeding portion 340, which is electrically connected to the first antenna units 310 and the first integrated circuit 330. The first feeding portion 340 can be connected to the first antenna units 310 and the first integrated circuit 330 through an outer surface of the support 200, that is, the first feeding portion 340 is arranged on the outer surface of the support 200.

In some other optional embodiments, referring to FIG. 1 to FIG. 6, the support 200 includes a connecting via hole 210 penetrating therethrough. At least a portion of the first feeding portion 340 is located in the connecting via hole 210 and electrically connected to the first antenna units 310 and the first integrated circuit 330, that is, the first feeding portion 340 is connected to the first antenna units 310 and the first integrated circuit 330 through the connecting via hole 210 inside the support 200. The first feeding portion 340 does not occupy an external space of the support 200, which can further reduce the distance between the first antenna units 310 and the first integrated circuit 330, thereby reducing the path loss between the first antenna units 310 and the first integrated circuit 330, and further reducing a size of a space occupied by the antenna module.

Optionally, the first antenna units 310 are electrically connected to the first integrated circuit 330 through the first feeding portion 340. In other embodiments, the number of the first feeding portions 340 connected to the same first antenna unit 310 is two or more, and the number of the connecting via holes 210 is also two or more. The first feeding portions 340 are located in the connecting via holes 210, respectively. For example, the number of the first feeding portions 340 is equal to the number of connecting via hole 210, or the number of connecting via holes 210 is larger than the number of the first feeding portions 340, so that the first feeding portions 340 can be connected to the first integrated circuit 330 and the first antenna units 310 through the connecting via holes 210 at the appropriate positions. The number of first feeding portions 340 connected to the same first antenna unit 310 is two or more, so as to facilitate the diversity transmission and reception of the wireless signals, reduce the probability of the wireless signal disconnection, facilitate the multiple-input multiple-output (MIMO) operation, and improve the wireless transmission rate.

There are various ways of the electrical connection between the first integrated circuit 330 and the first feeding portions 340, and the first integrated circuit 330 can be directly connected to the first feeding portions 340. Alternatively, in some other optional embodiments, as shown in FIG. 1 to FIG. 7, the antenna assembly 300 further includes a carrying portion 350. The first integrated circuit 330 is arranged on the carrying portion 350, the carrying portion 350 is provided with a signal line, and the first integrated circuit 330 is electrically connected to the first feeding portions 340 through the signal line, that is, the signal line is electrically connected between the first integrated circuit 330 and the first feeding portions 340.

There are various arrangements of the carrying portion 350. Optionally, the carrying portion 350 may be a flexible substrate, and a material of the carrying portion 350 may include a flexible material such as polyimide, which can facilitate the carrying portion 350 being attached to the support 200.

In some optional embodiments, the support 200 is provided with a groove 220, and the first antenna units 310 are located in the groove 220. The groove 220 can provide the positioning and limiting functions to the first antenna units 310. The groove 220 can form a reflector for the first antenna units 310, which can facilitate reflecting the antenna radiation beams of the first antenna units 310 outward and improving the performance of the first antenna module 301.

Optionally, two or more first antenna units 310 which are stacked can be arranged in the same groove 220.

There are various arrangements of the groove 220, as shown in FIG. 9, the number of the groove 220 may be one, and one groove 220 extends in an extending direction of the support 200. The plurality of first antenna units 310 may be located in the same groove 220, so that the implementation process can be simple, and the implementation cost can be reduced.

In some other optional embodiments, as shown in FIG. 1 to FIG. 10, the number of the grooves 220 can be two or more, a plurality of grooves 220 are spaced apart from one another. The first antenna units 310 are located in the grooves 220, respectively, so that the grooves 220 can provide the positioning and limiting functions to the first antenna units 310, respectively. In addition, the first antenna units 310 are located in the grooves 220, respectively, so that the isolation among the first antenna units 310 can increase, the performance of the antenna can be improved, and the quality of the wireless communication can be improved.

Optionally, when the support 200 is provided with the connecting via hole 210, the connecting via hole 210 can be located in the groove 220, that is, the connecting via hole 210 communicates with the groove 220. On one hand, a thickness of the support 200 where the groove 220 is located is relatively small, so as to facilitate the processing and forming of the connecting via hole 210; on the other hand, the first antenna units 310 are arranged in the groove 220, and the connecting via hole 210 is provided in the groove 220, so that a distance between the connecting via hole 210 and the first antenna units 310 can be further shorten.

Optionally, when there are the plurality of grooves 220 and the plurality of first feeding portions 340 connected to the same first antenna unit 310, the plurality of connecting via holes 210 can be provided in the same groove 220.

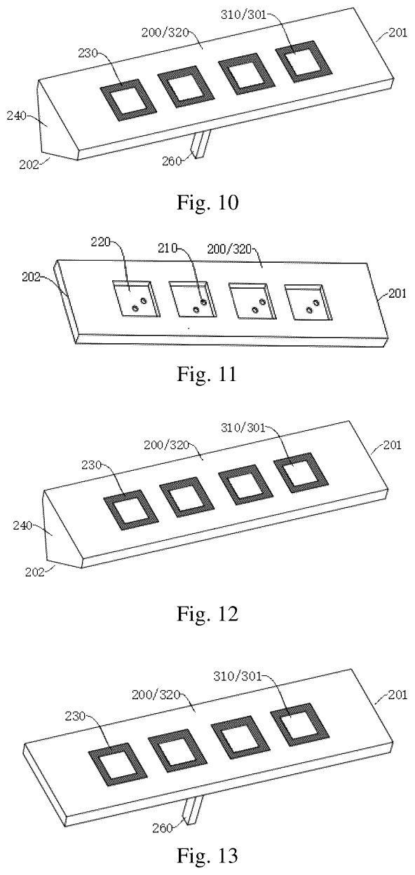

Optionally, as shown in FIG. 9 and FIG. 10, a filling medium 230 is provided between the first antenna units 310 and an inner wall face of the groove 220, so as to ensure the stability of the positions of the first antenna units 310. The filling medium 230, for example, may be at least one of fluorine material or liquid crystal polymer. Alternatively, the filling medium 230 may be adhesive, ceramic powder or other materials.

In some optional embodiments, the antenna device 10 further includes a shielding cover 400, which covers on a side of the first integrated circuit 330 away from the support 200, and the shielding cover 400 and the support 200 jointly surround to form a cavity for accommodating the first integrated circuit 330.

In these optional embodiments, the antenna device 10 is further provided with the shielding cover 400, the shielding cover 400 and the support 200 jointly surround to form the cavity, and the first integrated circuit 330 is located in the cavity, so that the support 200 and the shielding cover 400 can provide the comprehensive protection to the first integrated circuit 330, reduce the electromagnetic interference to the first integrated circuit 330 from the external environment or the electromagnetic interference from the first integrated circuit 330 to the external environment, and provide waterproof, dustproof, anti-collision and other protections for the first integrated circuit 330.

When the antenna assembly 300 further includes the carrying portion 350, the shielding cover 400 and the carrying portion 350 jointly surround to form the cavity that accommodates the first integrated circuit 330.

Optionally, the antenna assembly 300 further includes a connector 500, which is arranged on the support 200 and connected to the first integrated circuit 330, so that the first integrated circuit 330 can be electrically connected to the outer side through the connector 500 to perform the signal transmission. The connector 500 and the first integrated circuit 330 are spaced apart from each other on the same side of the support 200, and the connector 500 and the shielding cover 400 are spaced apart from each other in the extending direction of the support 200.

In these optional embodiments, the first integrated circuit 330 can be electrically connected to the outer side through the connector 500, for example, the first integrated circuit 330 can be electrically connected to the control board of the wireless mobile terminal through the connector 500. The connector 500 and the first integrated circuit 330 are arranged on the same side of the support 200, so as to reduce a distance between the connector 500 and the first integrated circuit 330, facilitate the electrical connection between the first integrated circuit 330 and the connector 500. The connector 500 and the shielding cover 400 are spaced apart from each other in the extending direction of the support 200. In the case that the shielding cover 400 is continued to be arranged after the first integrated circuit 330 is arranged, the situation where the shielding cover 400 is not placed correctly and collides with the connector 500 can be avoided.

Optionally, the plurality of sub-segments 110a of the border 110 include two first sub-segments extending in a first direction Y and spaced apart from each other and two second sub-segments extending in a second direction X and spaced apart from each other. The two first sub-segments and the two second sub-segments are surround and alternately connected in end-to-end to form the hollow space 120. The support 200 can be connected to the first sub-sections and/or the second sub-sections. Optionally, when the support 200 is connected to one of the two second sub-segments, the extending direction of the support 200 is a spacing direction between the two first sub-segments, that is, the extending direction of the support 200 is the first direction Y. When the support 200 is connected to one of the two first sub-segments, the extending direction of the support 200 is the second direction X.

In some optional embodiments, the support 200 is provided with a supporting portion 240. The supporting portion 240 extends from the support 200 towards the bottom plate 130 and is connected between the support 200 and the bottom plate 130. The supporting portion 240 support and is connected between the support 200 and the bottom plate 130, so as to ensure the stability of the position of the support 200.

Optionally, the support 200 includes a first end 201 and a second end 202 that are opposite to each other. The first end 201 is connected to the border 110, and the second end 202 is connected to the supporting portion 240. The supporting portion 240 extends from the second end 202 towards the bottom plate 130 and is connected between the second end 202 and the bottom plate 130.

In these optional embodiments, the first end 201 of the support 200 is connected to the border 110, the second end 202 away from the first end 201 is connected to the supporting portion 240, and the supporting portion 240 supports and is connected between the second end 202 and the bottom plate 130, so as to ensure the stability of the position of the support 200.

In some other embodiments, the supporting portion 240 can be arranged at any position of the support 200.

There are various arrangements of the supporting portion 240, for example, the supporting portion 240 may be in a shape of column, further, the supporting portion 240 may be in a shape of cylinder, prism or the like. The supporting portion 240 can be set with equal cross-sections in a direction from the support 200 to the bottom plate 130.

In some other optional embodiments, a cross-section of the supporting portion 240 gradually decreases in the direction from the support 200 to the bottom plate 130, which is conducive to matching the impedance of the second antenna module 302, conducive to improving the antenna performance and conducive to enhancing the structural stability.

Optionally, the bottom plate 130 includes a ground layer, the support 200 is electrically connected to the supporting portion 240, and the supporting portion 240 is electrically connected to the ground layer, so that the supporting portion 240 can be grounded through the ground layer of the bottom plate 130. The support 200 is reused as at least a portion of the second antenna units 320, so that the second antenna units 320 can be electrically connected through the ground layer of the support 200, the supporting portion 240 and the bottom plate 130.

In other embodiments, as shown in FIG. 11, the supporting portion 240 may not be provided on the support 200, and the border 110 is provided with a ground portion. The support 200 and the ground portion on the border 110 are connected to each other, that is, the support 200 which is reused as at least a portion of the second antenna units 320 is connected to the border 110, so as to achieve the grounding of the second antenna units 320. For example, when the border 110 includes the sub-segment 110a, the sub-segment 110a is provided with the ground portion, and the support 200 and the sub-segment 110a are connected to each other.

In some optional embodiments, as described above, when the border 110 includes the plurality of sub-segments 110a, at least one of the sub-segments 110a includes a conductive material and is reused as at least a portion of the second antenna units 320. The first end 201 of the support 200 is electrically connected to the sub-segments 110a reused as the second antenna units 320.

In these optional embodiments, at least a portion of the sub-segments 110a are reused as a portion of the second antenna units 320, which can further improve a distribution area of the second antenna module 302 and improve the wireless communication performance of the second antenna module 302. The first end 201 of the support 200 is electrically connected to the sub-segments 110a reused as the second antenna units 320, so that the support 200 and the sub-segments 110a can be jointly reused as the second antenna units 320, and the structure of the second antenna units 320 can be simplified.

In some optional embodiments, as shown in FIG. 10 to FIG. 13, the first end 201 of the support 200 can be directly connected and in contact with the border 110, that is, the support 200 is directly connected and in contact with the sub-segments 110a reused as the second antenna units 320, and a contact area between the support 200 and the sub-segments 110a is a cross-sectional area of the support 200. The support 200 has no contact portion 250, so the support 200 can be further away from the metal bottom plate 130, which can improve the antenna performance of the second antenna units 320, and occupies a relatively small area on the bottom plate 130.

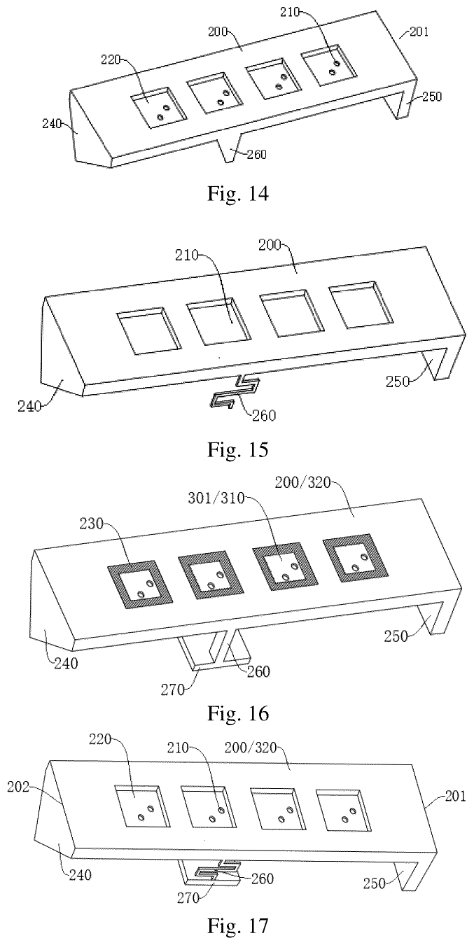

In other embodiments, as shown in FIG. 14 to FIG. 17, the first end 201 is provided with a contact portion 250. The contact portion 250 extends from the first end 201 towards the bottom plate 130 and is connected to the border 110. The contact portion 250 can increase the contact area between the support 200 and the sub-segments 110a of the border 110, ensure the stability of the position of the support 200, and reduce the resistance.

Optionally, when the support 200 is connected to the ground portion of the border 110, the support 200 can be directly connected to the ground portion of the border 110. A conductive portion is exposed from a cross-section of the support 200 facing the border 110, and the support 200 is connected to the ground portion of the border 110 through the conductive portion. Alternatively, the support 200 can be connected to the ground portion of the border 110 through the contact portion 250.

Optionally, the contact portion 250 and the support 200 can be integrally formed, so as to simplify the structure of the antenna device 10.

Optionally, an end of the contact portion 250 away from the first end 201 is connected to the bottom plate 130, so as to further ensure the stability of the position of the support 200.

Optionally, the antenna assembly 300 further includes a second feeding portion 260. The second feeding portion 260 is electrically connected to the support 200, so that the second antenna units 320 can be fed in through the second feeding portion 260.

Optionally, the supporting portion 240 as described above can be reused as the second feeding portion 260, in this case, the supporting portion 240 is not electrically connected to the ground layer of the bottom plate 130. For example, when the bottom plate 130 and the control board are reused, a second integrated circuit is arranged on the bottom plate 130, the second feeding portion 260 can be electrically connected to the second integrated circuit on the bottom plate 130, and the supporting portion 240 reused as the second feeding portion 260 can be electrically connected to the second integrated circuit.

In some other embodiments, the second feeding portion 260 and the supporting portion 240 are spaced apart from each other on the support 200. The second feeding portion 260 can be electrically connected to the second integrated circuit as described above, the supporting portion 240 can be electrically connected to the ground layer, and the second feeding portion 260 and the supporting portion 240 are respectively used to achieve different functions.

Optionally, the number of the supporting portions 240 is two or more, and a plurality of supporting portions 240 are spaced apart from one another on the support 200; and/or, the number of the second feeding portions 260 is two or more, and a plurality of second feeding portions 260 are spaced apart from one another.

Optionally, the second feeding portion 260 may be arranged on the side of the support 200 facing the bottom plate 130, and the second feeding portion extends from the support 200 towards the bottom plate 130, so as to utilize a gap between the support 200 and the bottom plate 130 to arrange the second feeding portion 260 and reduce the overall structural size of the antenna device 10.

Optionally, the second feeding portion 260 is connected to the bottom plate 130, that is, the second feeding portion 260 is connected between the bottom plate 130 and the support 200, which can further improve the structural stability of the support 200.

Optionally, as shown in FIG. 14, in a direction from the bottom plate 130 to the support 200, a cross-sectional area of the second feeding portion 260 gradually increases, which is conducive to matching the input impedance of a non-millimeter wave antenna, can allow the energy fed into the second feeding portion 260 to radiate to a larger extent, and can improve the antenna performance and the wireless communication quality of the non-millimeter wave antenna.

Optionally, as shown in FIG. 15, the second feeding portion 260 can be formed by extending along a bending path, so as to increase a length of an extending path of the second feeding portion 260, improve the inductance performance of the second feeding portion 260, facilitate matching the impedance, and allow the energy fed into the second feeding portion 260 to radiate out to a larger extent. In addition, the length of the second antenna module 302 can be extended, so as to better cover the lower frequency band in the case of the same appearance (such as the same number and position of metal gaps).

Optionally, as shown in FIG. 16, the second feeding portion 260 is connected to a conductive plate 270. The conductive plate 270 includes an adjustment plane facing the bottom plate 130, and the adjustment plane intersects with a spacing direction between the bottom plate 130 and the support 200. For example, the bottom plate 130 and the support 200 are spaced apart from each other in a third direction Z, and the adjustment plane intersects with the third direction Z. By arranging the conductive plate 270, a parasitic capacitance is formed between the conductive plate 270 and the ground layer of the bottom plate 130, which is conducive to matching the impedance of the non-millimeter wave, can allow the energy fed into the second feeding portion 260 to radiate to a larger extent, and can improve the antenna performance and the wireless communication quality of the non-millimeter wave antenna.

Optionally, as shown in FIG. 17, the second feeding portion 260 extends along the bending path, and the conductive plate 270 can be arranged on the second feeding portion 260, so as to adjust the capacitance and the inductance characteristics of the input impedance of the non-millimeter wave antenna with higher degrees of freedom, make the input impedance more matched, allow the energy fed into the second feeding portion 260 to radiate to a larger extent, and improve the antenna performance and wireless communication quality of the non-millimeter wave antenna.

Optionally, the second feeding portion 260 may include a straight segment and a bending segment distributed in the third direction Z (i.e., the spacing direction between the support 200 and the bottom plate 130). When the conductive plate 270 is connected to the second feeding portion 260, the conductive plate 270 may be located on a side of the bending segment facing or away from the bottom plate 130. The straight segment may also be located on the side of the bending segment facing or away from the bottom plate 130.

Optionally, as shown in FIG. 11, the support 200 may be not provided with the supporting portion 240 and the second feeding portion 260, so as to minimize an occupied area of the support 200, allow the support 200 to become another branch of the second antenna module 302 to cover the new non-millimeter wave frequency band, and facilitate achieving the design of a multi-frequency non-millimeter wave antenna.

Optionally, as shown in FIG. 12, the support 200 may be provided with the supporting portion 240 without the second feeding portion 260. Alternatively, in some other embodiments, as shown in FIG. 13, the support 200 may be provided with the second feeding portion 260 without the supporting portion 240, and the second feeding portion 260 has the functions of feeding and supporting.

In a second aspect, embodiments of the present application provide a wireless mobile terminal including the antenna device 10 according to any one of the above embodiments in the first aspect. Since the wireless mobile terminal provided by the embodiments of the present application in the second aspect includes the antenna device 10 according to any one of the above embodiments in the first aspect, the wireless mobile terminal provided by the embodiments of the present application in the second aspect has the beneficial effects of the antenna device 10 according to any one of the above embodiments in the first aspect, which will not be repeated here.

The wireless mobile terminal in the embodiments of the present application includes but is not limited to a device with the wireless communication function, such as a mobile phones, a personal digital assistants (PDA), a tablet, an e-books, a television, an access control, a smart landline phone or a console.

Although the present disclosure has been described with reference to the optional embodiments, various modifications may be made to the present disclosure and components may be replaced with equivalents without departing from the scope of the present disclosure. In particular, the technical features mentioned in the various embodiments can be combined in any manner as long as there is no structural conflict. The present disclosure is not limited to the specific embodiments disclosed herein, but includes all technical solutions falling within the scope of the claims.

What is claimed is:

1. An antenna device, comprising:
a frame, comprising a border and a hollow space surrounded and formed by the border;
a support, connected to the border and extending towards the hollow space; and
an antenna assembly, comprising a first antenna module and a second antenna module, the first antenna module being arranged on the support and comprising a plurality of first antenna units spaced apart from one another, and the second antenna module comprising a plurality of second antenna units,
the first antenna module and the support being insulated from each other, and the support comprising a conductive material and being reused as at least a portion of the second antenna units.

2. The antenna device according to claim 1, wherein the first antenna module is a millimeter wave antenna module, and the first antenna units are configured to transmit and receive a millimeter wave antenna signal;
the second antenna module is a non-millimeter wave antenna module, and the second antenna units are configured to transmit and receive a non-millimeter wave antenna signal.

3. The antenna device according to claim 1, wherein the frame further comprises a bottom plate, the bottom plate is connected to the border, the bottom plate and the border jointly surround to form the hollow space, and the support and the bottom plate are spaced apart from each other; and
the border is provided with a ground portion, and the support is connected to the ground portion.

4. The antenna device according to claim 3, wherein the antenna assembly further comprises a first integrated circuit, one of the first integrated circuit and the first antenna units is arranged on a side of the support facing the bottom plate, another of the first integrated circuit and the first antenna units is arranged on a side of the support away from the bottom plate, and the first integrated circuit is electrically connected to the first antenna units.

5. The antenna device according to claim 4, wherein the first integrated circuit is arranged on the side of the support facing the bottom plate, and the first antenna units are arranged on the side of the support away from the bottom plate.

6. The antenna device according to claim 4, wherein the support comprises a connecting via hole penetrating therethrough, and the first antenna module comprises a first feeding portion, at least a portion of the first feeding portion is located in the connecting via hole, and the first feeding portion is electrically connected to the first antenna units and the first integrated circuit.

7. The antenna device according to claim 6, wherein the first antenna module comprises two or more first feeding portions connected to the same first antenna unit, the support comprises two or more connecting via holes, and the first feeding portions correspond to the connecting via holes, respectively.

8. The antenna device according to claim 6, wherein the antenna assembly further comprises a carrying portion, the first integrated circuit is arranged on the carrying portion, the carrying portion is provided with a signal line, and the first integrated circuit is electrically connected to the first feeding portion through the signal line; and
the support is provided with a groove, and the first antenna units are located in the groove.

9. The antenna device according to claim 7, wherein the support is provided with a plurality of grooves spaced apart from one another, and the first antenna units correspond to the grooves, respectively;
the connecting via holes are located in the grooves; and
a filling medium is provided between the first antenna units and inner wall faces of the grooves.

10. The antenna device according to claim 4, further comprising a shielding cover, wherein the shielding cover is arranged to cover on a side of the first integrated circuit away from the support, and the shielding cover and the support jointly surround to form a cavity for accommodating the first integrated circuit.

11. The antenna device according to claim 10, wherein the antenna assembly further comprises a connector, the connector is arranged on the support and connected to the first integrated circuit, the first integrated circuit is electrically connected to an outer side through the connector, the connector and the first integrated circuit are spaced apart from each other on the same side of the support, and the connector and the shielding cover are spaced apart from each other in an extending direction of the support.

12. The antenna device according to claim 3, wherein the support is provided with a supporting portion, and the supporting portion extends from the support towards the bottom plate and is connected to the bottom plate.

13. The antenna device according to claim 12, wherein the support comprises a first end and a second end opposite to each other, the first end is connected to the border, the second end is connected to the supporting portion, and the supporting portion extends from the second end towards the bottom plate and is connected to the bottom plate.

14. The antenna device according to claim 13, wherein a cross-section of the supporting portion gradually decreases in a direction from the support to the bottom plate; and
the bottom plate comprises a ground layer, the support is electrically connected to the supporting portion, and the supporting portion is electrically connected to the ground layer.

15. The antenna device according to claim 13, wherein the frame comprises a plurality of sub-segments arranged around the hollow space and spaced apart from one another, at least one of the sub-segments comprises a conductive material and is reused as at least a portion of the second antenna units, and the first end of the support is electrically connected to the at least one of the sub-segments reused as the at least a portion of the second antenna units.

16. The antenna device according to claim 15, wherein the support is directly connected to the border through the first end;
or the first end is provided with a contact portion, and the contact portion extends from the first end towards the bottom plate and is connected to the border.

17. The antenna device according to claim 15, wherein the support is provided with a second feeding portion, and the second feeding portion is electrically connected to the support.

18. The antenna device according to claim 17, wherein the second feeding portion is arranged on the side of the support facing the bottom plate, and the second feeding portion extends from the support towards the bottom plate;
the second feeding portion is connected to the bottom plate; and
the second feeding portion and the supporting portion are reused as each other, or the second feeding portion and the supporting portion are spaced apart from each other.

19. The antenna device according to claim 18, wherein an area of a cross-section of the second feeding portion gradually decreases in the direction from the support to the bottom plate;
the second feeding portion extends along a bending path;
the second feeding portion is provided with and connected to a conductive plate, the conductive plate comprises an adjustment plane facing the bottom plate, and the adjustment plane intersects with a spacing direction between the bottom plate and the support.

20. A wireless mobile terminal, comprising the antenna device according to claim 1.
